(19) United States
(12) Patent Application Publication
(10) Pub. No.: US 2010/0085268 A1
(43) Pub. Date: Apr. 8, 2010

(54) ANTENNA

(75) Inventors: Shih-Huang Yeh, Hsinchu City (TW); Tzh-Hao Lu, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Sunplus mMobile Inc., Hsinchu (TW)

(21) Appl. No.: 12/575,453

(22) Filed: Oct. 7, 2009

(30) Foreign Application Priority Data
Oct. 8, 2008 (TW) 97138711

(51) Int. Cl. H01Q 5/02; H01Q 1/36; H01Q 9/26; H01Q 7/00; H01Q 1/48

(52) U.S. Cl. 343/803; 343/700 MS; 343/843; 343/866; 343/848

(57) ABSTRACT

An antenna having a number of operating frequencies includes a feed element, a ground element, and a number of conductive antenna tracks. The conductive antenna tracks extend outward from the feed element and return back to the ground element. When the conductive antenna tracks are located in a same plane, areas defined by the conductive antenna tracks are not overlapped with one another. When parts of the conductive antenna tracks are located in different planes, multiple frequency bands are formed respectively by multiple resonant frequencies corresponding to the conductive antenna tracks.

### CROSS-REFERENCE TO RELATED APPLICATION

This application claims the priority benefit of Taiwan application serial no. 97138711, filed on Oct. 8, 2008. The entirety of the above-mentioned patent application is hereby incorporated by reference herein and made a part of specification.

### BACKGROUND OF THE INVENTION

1. Field of the Invention

The present invention generally relates to antennas, and more particularly, to an antenna operable in multiple frequency bands.

2. Description of Related Art

With advancement of science and technology, wireless communications become more and more popular. For example, cell phones, personal digital assistants (PDAs) accessible to wireless network, and global positioning systems (GPSs) have been widely applied to wireless communications. Nevertheless, an antenna is often required for transmitting information.

Architectures of antennas can be categorized into different types, e.g., dipole antennas, bow-tie antennas, horn antennas, etc., each of which is featured by individual characteristics and performance. For example, dipole antennas are characterized by omni-directions fields, bow-tie antennas are featured by relatively wide operation frequency bands, and horn antennas have larger gains. Correspondingly, each of these types of antennas also features by particular disadvantages. For example, a dipole antenna usually has a narrower operation frequency band. A field of a bow-tie antenna is usually inconsistent when the antenna is operated at different frequencies. A horn antenna is not suitable in mobile communication. Therefore, antennas should be designed in accordance with practical demands on different kinds of wireless communications.

Generally, an antenna for a typical wireless electronic apparatus is often a planar inverted-F antenna (PIFA). The fundamental mode of the PIFA is operated at a ¼ wavelength, and therefore the length of the PIFA can be reduced. However, current and future wireless electronic products are demanded or desired to be lighter, slimmer, smaller, and more compact than ever before. As such, even though the length of the PIFA can be reduced when designing an antenna, a certain distance between the PIFA and the ground plane should be maintained, and therefore the PIFA unavoidably occupies a certain space of the wireless electronic product. The design of the wireless electronic product is limited, especially when the features of lightness and slimness are highly desired.

Further, current wireless electronic products are apt to be designed with multiple functions, i.e., a plurality of wireless communication applications are consciously integrated into an individual wireless electronic product. However, different wireless communication applications have different frequency bands, and even a single wireless communication application may have multiple frequency bands. For example, a conventional global system for mobile communication (GSM) employs four frequency bands. As such, the design of an antenna operable at multiple frequency bands is a trend of wireless communications.

In accordance with the design concept of multiple frequencies and lightness and slimness, antennas are little by the architectures of a loop antenna or a folded dipole antenna for achieving the required operation frequency bands and radiation features, thus effectively reducing the sizes of the antennas.

U.S. Pat. No. 7,307,591 discloses a multi-band loop antenna. Unfortunately, a second mode and a third operation mode cannot be easily adjusted by means of the multi-band loop antenna, and therefore it is difficult for the multi-band loop antenna to be operated at a desired frequency and a frequency band. U.S. Pat. No. 7,265,726 discloses a multi-band antenna integrating a loop antenna with a folded dipole antenna. However, such a multi-band antenna disadvantageously occupies an excessive area. Further, the feed point of the multi-band antenna is overly far away from the ground point, and thus the multi-band antenna is not suitable for being applied in mobile phones. U.S. Patent Application Publications No. 2006/0232477, No. 2007/0115200, No. 2007/0222699, and U.S. Pat. No. 7,042,402 disclose 3-dimensional (3D) loop antennas and folded dipole antennas. Although these disclosed 3D antennas are suitable for multi-band operations, the 3D structures increase the costs and structural complexity of fabricating the antennas. In addition to the aforementioned disadvantages and defects, it is also inconvenient for fine tuning the operation frequencies of the antennas by conducting any of the previously mentioned conventional techniques, which further increases the difficulty and complexity in developing and designing the antenna.

### SUMMARY OF THE INVENTION

Accordingly, the present invention is directed to an antenna operable at multiple operation frequencies. The antenna includes a plurality of conductive antenna tracks. All of the conductive antenna tracks are located in a same plane. Areas defined by the conductive antenna tracks are not overlapped with one another.

The present invention is further directed to an antenna having multiple operation frequencies. The antenna includes a plurality of conductive antenna tracks. Parts of the conductive antenna tracks are located in different planes. The antenna has a plurality of resonant frequencies. The resonant frequencies constitute several frequency bands. The operation frequencies are included in the frequency bands. Each of the resonant frequencies is independent.

The present invention provides an antenna applicable for handled device and operating at a plurality of operation frequencies. The antenna includes a feed element, a ground element, and M conductive antenna tracks. The M conductive antenna tracks are located in a same plane. The M conductive antenna tracks have an end coupled to the feed element and the other end coupled to the ground element respectively, and therefore each of the conductive antenna tracks forms an area. The area starts from a joint of the conductive antenna track and the feed element and extends along the conductive antenna track to a joint of the conductive antenna track and the ground element. A k^{th} conductive antenna track defines a k^{th} area. An i^{th} area is not overlapped with a j^{th} area, in which M is a positive integer greater than or equal to 2, i, j, and k are positive integers smaller than or equal to M, and i is not equal to j.

According to an embodiment of the present invention, the conductive antenna tracks respectively correspond to a plurality of resonant frequencies, and constitute a plurality of frequency bands. Each of the frequency bands covers one of the operation frequencies operable for the antenna. The resonant frequencies correspond to a plurality of wavelengths, respectively. A length of each of the conductive antenna track approximates to half of a wavelength corresponding to the resonant frequency of the conductive antenna track.

The present invention further provides an antenna applicable for handled device and operating at a plurality of operation frequencies. The antenna includes a feed element, a ground element, and at least two conductive antenna tracks. The conductive antenna tracks are located in different planes. Each of the conductive antenna tracks includes an end coupled to the feed element and the other end coupled to the ground element. The conductive antenna tracks respectively correspond to a plurality of resonant frequencies and constitute a plurality of frequency bands covering the operation frequencies corresponding thereto.

According to an embodiment of the present invention, when the resonant frequency of each of the conductive antenna tracks operated at the antenna is double, current zeros configured on the conductive antenna tracks comprises a first current zero and a second current zero, the antenna further includes a conductive element having a first end coupled to the first current zero and the other end coupled to the second current zero.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a side view of an antenna according to an embodiment of the present invention.

FIG. 1B is a top view of an antenna according to an embodiment of the present invention.

FIG. 2A is a side view of an antenna according to another embodiment of the present invention.

FIG. 2B is a top view of an antenna according to another embodiment of the present invention.

FIG. 2C is diagram depicting a return loss of an antenna according to another embodiment of the present invention.

FIG. 3 is a side view of an antenna according to a further embodiment of the present invention.

FIG. 4A is a side view of an antenna according to a further embodiment of the present invention.

FIG. 4B is a top view of an antenna according to a further embodiment of the present invention.

FIG. 5A is a top view of an antenna according to a still further embodiment of the present invention.

FIG. 5B is a top view of an antenna further including a conductive element according to a still further embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

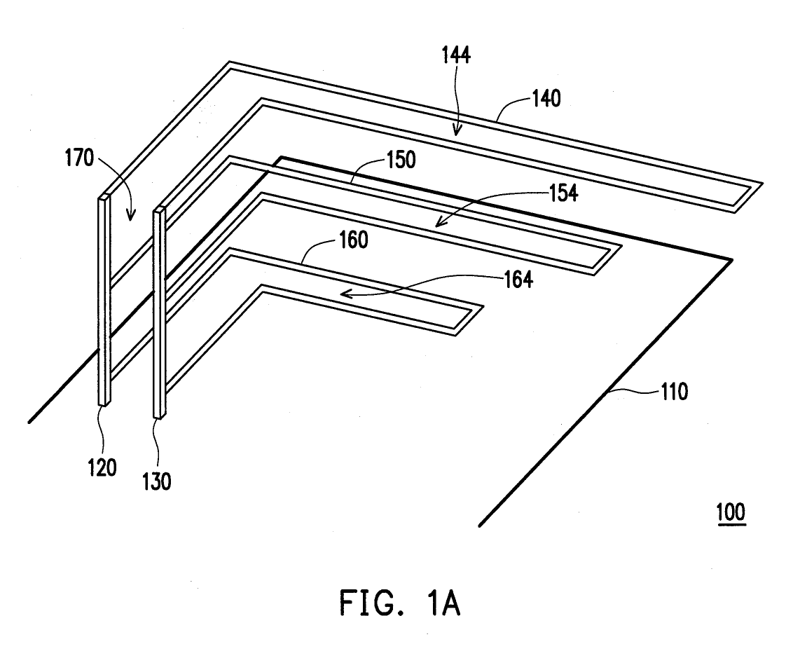

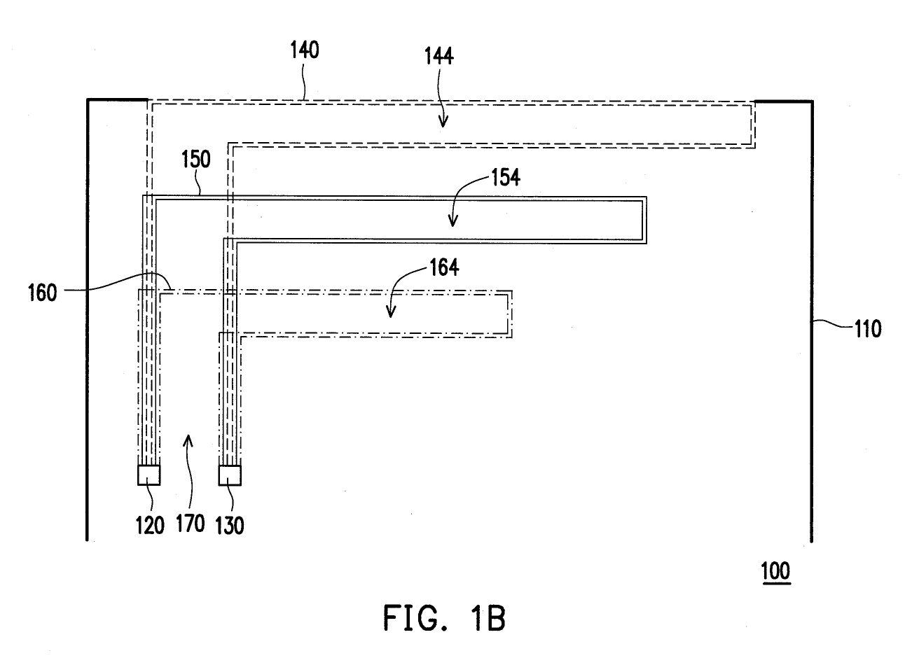

FIGS. 1A and 1B respectively illustrate a side view and a top view of an antenna according to an embodiment of the present invention. Referring to FIGS. 1A and 1B, an antenna 100 is shown. The antenna 100 includes a feed element 120, a ground element 130, M conductive antenna tracks (e.g., a first conductive antenna track 140, a second conductive antenna track 150, and a third conductive antenna track 160, as exemplified in the current embodiment), in which M is a positive integer greater than or equal to 2. The ground element 130 is suitable for connecting a ground plane 110. The ground plane 110, for example, can be a ground plane of a system or a backplate of an LCD which includes a large metal surface. The number of the conductive antenna tracks is merely exemplary for illustration purpose. The first conductive antenna track 140, the second conductive antenna track 150, and the third conductive antenna track 160 extend outward from the feed element 120 and return back to the ground element 130. The first conductive antenna track 140, the second conductive antenna track 150, and the third conductive antenna track 160 are located in different planes. For example, these three conductive antenna tracks 140, 150, and 160 are located in three different planes which are parallel with one another and are parallel with the ground plane 110.

Widths of the first conductive antenna track 140, the second conductive antenna track 150, and the third conductive antenna track 160 can be equivalent, not equivalent, or partially equivalent. In other words, a width of the first conductive antenna track 140, a width of the second conductive antenna track 150, and a width of the third conductive antenna track 160 at any cross-section thereof are adjustable. It can be learned from FIGS. 1A and 1B that there exists a separation space 170 between the feed element 120 and the ground element 130. The first conductive antenna track 140, the second conductive antenna track 150, and the third conductive antenna track 160 are distributed outside the separation space 170.

As shown in FIGS. 1A and 1B, the track 140 defines an area 144, the track 150 defines an area 154, and the track 160 defines an area 164. As shown in FIG. 1B, an orthogonal projection area of the area 144 projected on the plane in which the area 154 is located is not completely overlapped with the area 154, and an orthogonal projection area of the area 144 projected on the plane in which the area 164 is located is also not completely overlapped with the area 164. Similarly, an orthogonal projection area of the area 154 projected on the plane in which the area 144 is located is not completely overlapped with the area 144, and an orthogonal projection area of the area 154 projected on the plane in which the area 164 is located is also not completely overlapped with the area 164. Likewise, an orthogonal projection area of the area 164 projected on the plane in which the area 144 is located is not completely overlapped with the area 144, and an orthogonal projection area of the area 164 projected on the plane in which the area 154 is located is also not completely overlapped with the area 154. Briefly, an orthogonal projection area of any one of the areas 144, 154, and 164 projected on another one of the three areas 144, 154, and 164 is not completely overlapped with the another one of the three areas 144, 154, and 164.

Further, the first conductive antenna track 140, the second conductive antenna track 150, and the third conductive antenna track 160 correspond to three resonant frequencies, respectively. Because of the ground element 130, lengths of the conductive antenna tracks can be shortened to about halves of wavelengths respectively corresponding thereto. In other words, the length of the first conductive antenna track 140 is approximately half of a wavelength corresponding to the resonant frequency corresponding to the first conductive antenna 140. The length of the second conductive antenna track 150 is approximately half of a wavelength corresponding to the resonant frequency corresponding to the second conductive antenna 150. The length of the third conductive antenna track 160 is approximately half of a wavelength corresponding to the resonant frequency corresponding to the third conductive antenna 160. Three frequency bands at which the antenna 100 can be operated are thus correspondingly formed around these three resonant frequencies. These three frequency bands cover the operation frequencies of the antenna 100, and therefore the antenna 100 can be operated at any of the operation frequencies. In other words, if the antenna 100 includes M conductive antenna tracks, the length of the n^{th} conductive antenna track is approximately half of a wavelength corresponding to the resonant frequency corresponding to the n^{th} conductive antenna track, in which M is a positive integer greater than or equal to 2, and n is a positive integer smaller than or equal to M.

The antenna 100 has three resonant frequencies controlled by the first conductive antenna track 140, the second conductive antenna track 150, and the third conductive antenna track 160, respectively. Therefore, the three resonant frequencies of the antenna 100 are independent from one another. As such, when any one of the three resonant frequencies is to be adjusted, only the length of the conductive antenna track corresponding to the resonant frequency to be adjusted is required to be changed, while the lengths of the rest of conductive antenna tracks corresponding to resonant frequencies which are not desired to be adjusted remain unchanged. For example, when it is desired to lower the resonant frequency corresponding to the first conductive antenna track 140, the first conductive antenna track 140 should be elongated, while the second conductive antenna track 150 and the third conductive antenna track 160 need not to be changed.

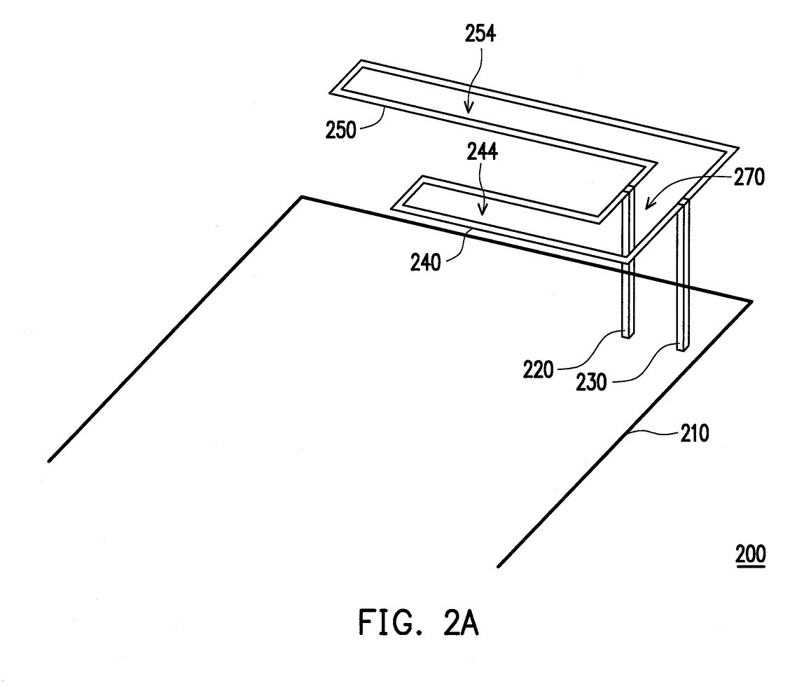

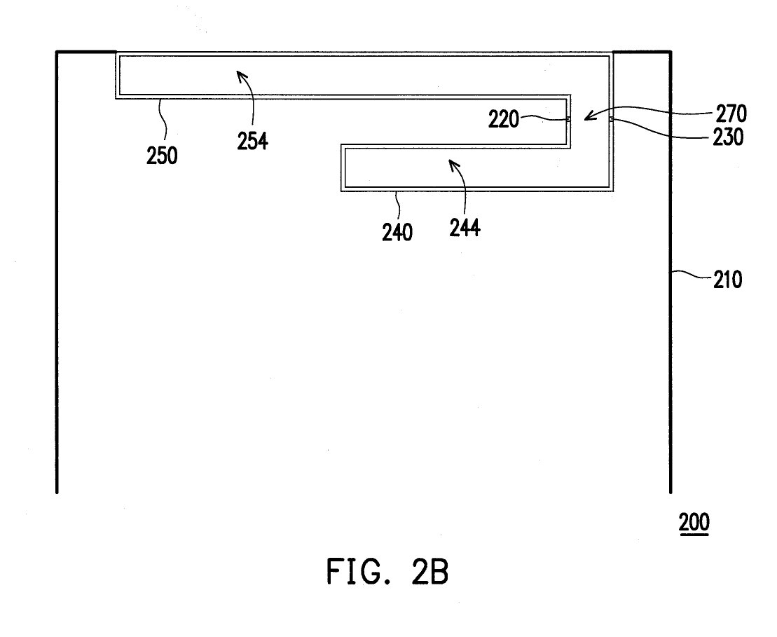

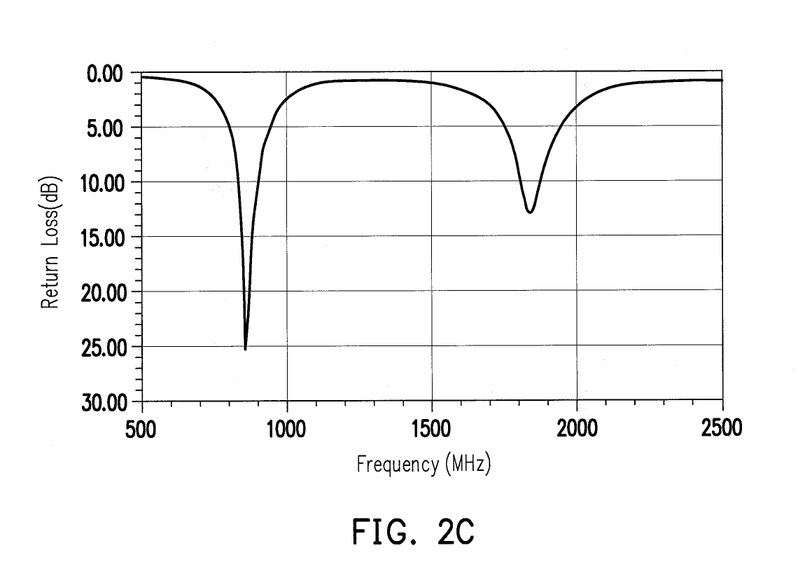

FIGS. 2A and 2B respectively illustrate a side view and a top view of an antenna according to another embodiment of the present invention. Referring to FIGS. 2A and 2B, an antenna 200 is shown. The antenna 200 includes a feed element 220, a ground element 230, M conductive antenna tracks (e.g., a first conductive antenna track 240 and a second conductive antenna track 250 as exemplified in the current embodiment), in which M is a positive integer greater than or equal to 2. The ground element 230 is suitable for connecting a ground plane 210. The ground plane 210, for example, can be a ground plane of a system or a backplate of an LCD which includes a large metal surface. The first conductive antenna track 240 and the second conductive antenna track 250 extend outward from the feed element 220 and return back to the ground element 230. The first conductive antenna track 240 and the second conductive antenna track 250 are distributed outside a separation space 270 between the feed element 220 and the ground element 230. The first conductive antenna track 240 and the second conductive antenna track 250 are located in a same plane. The first conductive antenna track 240 defines an area 244, and the second conductive antenna track 250 defines an area 254. The area 244 and the area 254 are not overlapped with each other.

Compared with the embodiment as shown in FIGS. 1A and 1B, the current embodiment differs in that the first conductive antenna track 240 and the second conductive antenna track 250 are located in a same plane which is parallel with the ground plane 210. As such, if only one of the first conductive antenna track 240 and the second conductive antenna track 250 does not encompass the other conductive antenna track, the area 244 and the area 254 are not overlapped each other.

For example, the ground plane has an area of 55×100 mm², and the first conductive antenna track 240 and the second conductive antenna track 250 are both printed on a glass fiber plate (e.g., an FR4 substrate) and disposed for example 3 mm to 10 mm away from the ground plane 210. A width of the first conductive antenna track 240 for example is 1 mm. A track-to-track distance of the first conductive antenna track 240 for example is 0.5 mm. A total length of the first conductive antenna track 240 for example is 57 mm A width of the second conductive antenna track 250 for example is 1 mm. A track-to-track distance of the second conductive antenna track 250 for example is 1 mm. A total length of the second conductive antenna track 250 for example is 100 mm. In this case, the return loss is shown in FIG. 2C. When operated at a frequency of about 900 MHz, the antenna 200 has a resonant frequency and forms a frequency band, and when operated at a frequency of about 1850 MHz, the antenna 200 has another resonant frequency and forms another frequency band.

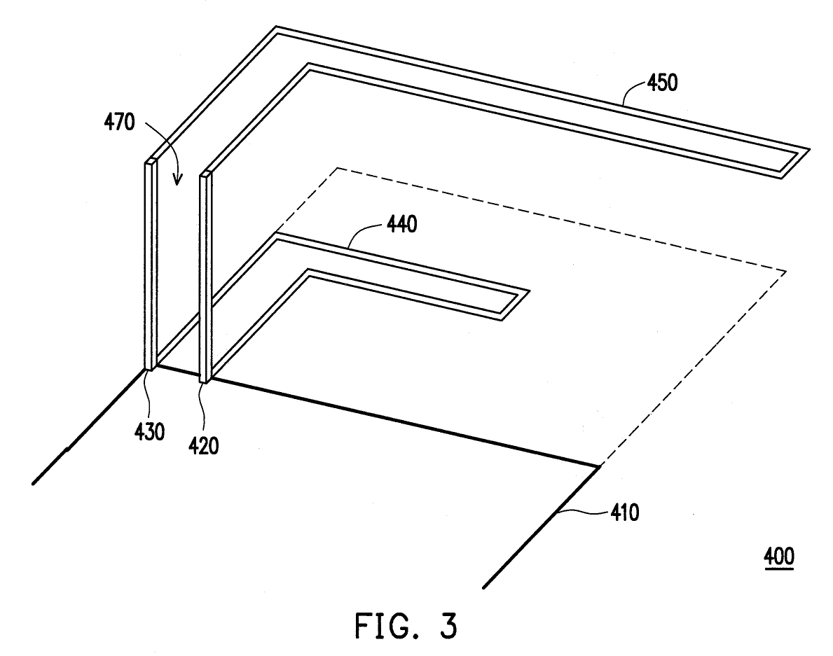

FIG. 3 is a side view of an antenna according to a further embodiment of the present invention. Referring to FIG. 3, an antenna 400 includes a feed element 420, a ground element 430, a first conductive antenna track 440, and a second conductive antenna track 450. A ground plane 410 is coupled with the ground element 430. The architecture and the operating principle explained the current embodiment are similar to those described in the embodiment shown in FIGS. 1A and 1B and therefore are not to be iterated hereby.

However, it should be noted that the current embodiment differs from the embodiment of FIGS. 1A and 1B in that the first conductive antenna track 440 is located in a plane in which the ground plane 410 is also located. As shown in FIG. 3, the first conductive antenna track 440 is directly distributed in the plane of the ground plane 410.

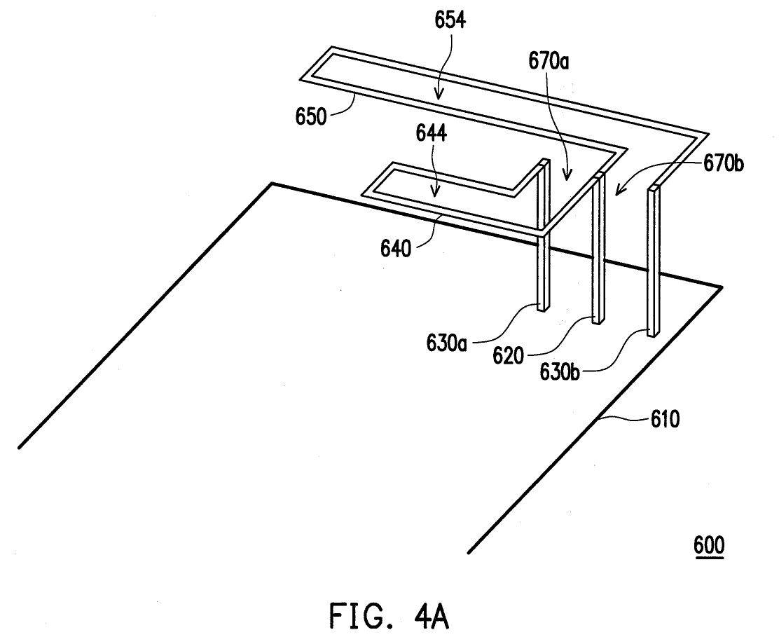

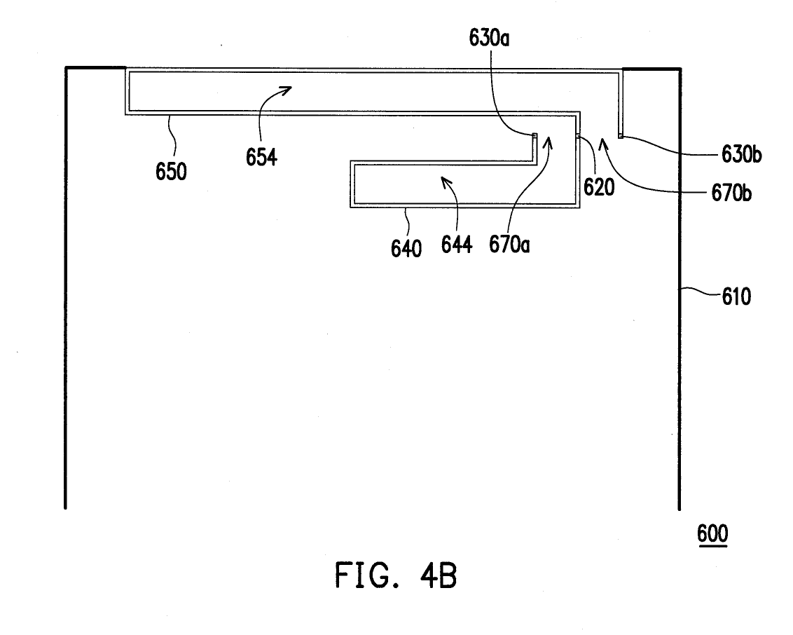

FIGS. 4A and 4B respectively illustrate a side view and a top view of an antenna according to a further embodiment of the present invention. Referring to FIGS. 4A and 4B, an antenna 600 includes a feed element 620, a first ground sub-element 630a, a second ground sub-element 630b, a first conductive antenna track 640, and a second conductive antenna track 650. A ground plane 610 is coupled to the first ground sub-element 630a and the second ground sub-element 630b. The architecture and the operating principle explained in the current embodiment are similar to the embodiment shown in FIGS. 2A and 2B. The first conductive antenna track 640 extends out from the feed element 620 and returns back to the first ground sub-element 630a. The first conductive antenna track 640 is distributed outside a first separation space 670a between the feed element 620 and the first ground sub-element 630a. The second conductive antenna track 650 extends out from the feed element 620 and returns back to the second ground sub-element 630b. The second conductive antenna track 650 is distributed outside a second separation space 670b between the feed element 620 and the second ground sub-element 630b. The first conductive antenna track 240 and the second conductive antenna track 250 are located in a same plane. The track 640 defines an area 644, and the track 650 defines an area 654. The area 644 and the area 654 are not overlapped with each other.

However, it should be noted that the current embodiment differs from the embodiment of FIGS. 2A and 2B in that the current embodiment replaces the ground element 230 of FIGS. 2A and 2B with the first ground sub-element 630a and the second ground sub-element 630b of FIGS. 4A and 4B. As such, the first conductive antenna track 640 and the second conductive antenna track 650 can be individually coupled to the first ground sub-element 630a and the second ground sub-element 630b, respectively.

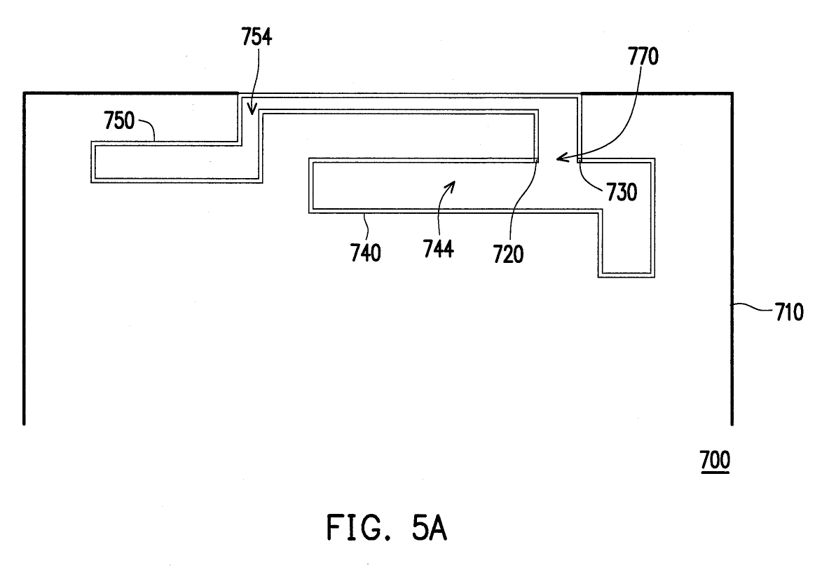

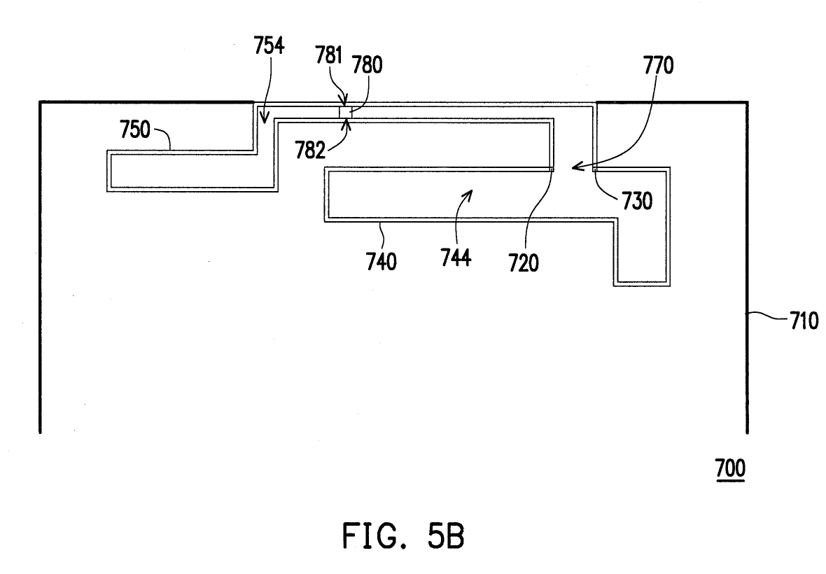

FIG. 5A is a top view of an antenna according to a still further embodiment of the present invention. Referring to FIG. 5A, it shows an antenna 700. The antenna 700 includes a feed element 720, a ground element 730, a first conductive antenna track 740, and a second conductive antenna track 750. The first conductive antenna track 740 and the second conductive antenna track 750 are located in the same plane. A ground plane 710 is coupled to the ground element 730. The architecture and the operating principle explained in the current embodiment are similar to the embodiment shown in FIGS. 2A and 2B. The first conductive antenna track 740 and the second conductive antenna track 750 extend outward from the feed element 720 and return back to the ground element 730. The first conductive antenna track 740 and the second conductive antenna track 750 are distributed outside a separation space 770 between the feed element 720 and the ground element 730. The first conductive antenna track 740 defines an area 744, and the second conductive antenna track 750 defines an area 754. The area 744 and the area 754 are not overlapped with each other.

Compared with the embodiment as shown in FIGS. 2A and 2B, the current embodiment differs in that the first conductive antenna track 740 and the second conductive antenna track 750 are extendingly configured with more turns. In such a way, the first conductive antenna track 740 and the second conductive antenna track 750 can be more flexibly distributed and adjusted so as to achieve specific characteristic requirements. Further, although the angles of the turns made by the extending conductive antenna tracks are shown as right angles, the present invention is not restricted to those described above. The turns can be made with any other angles, or even turns in an arc shape.

Further, due to some coupling correlations, in addition to a first resonant frequency corresponding to the first conductive antenna track 740 and a second resonant frequency corresponding to the second conductive antenna track 750, the antenna 700 further has a third resonant frequency. The third resonant frequency for example is an average of the first resonant frequency and the second resonant frequency. When it is desired to depress the third frequency, for example as shown in FIG. 5B, a conductive element 780 is provided. One end of the conductive element 780 is connected to the second conductive antenna track 750 of the antenna 700 at a place where a first current zero 781 is located around. The other end of the conductive element 780 is connected to the second conductive antenna track 750 of the antenna 700 at a place where a second current zero 782 is located around. The positions of the first current zero 781 and the second current zero 782 are positions of current zeros formed on the second conductive antenna track 750 when the antenna 700 is operated at the double frequency of the second resonant frequency, i.e., the third resonant frequency (for example positions in a distant of ⅛ wavelength corresponding to the second resonant frequency away from the feed element and the ground element). The depression of the resonant frequency according to the present invention is not restricted to those described above. For example, the conductive element 780 can also be connected to anywhere else of the second conductive antenna track 750, e.g., a 1/16 wavelength corresponding to the second resonant frequency. Similarly, the conductive element 780 can also be coupled to the first conductive antenna track 740 for depressing another additional resonant frequency.

It should be clarified that the feed elements and the ground elements illustrated in all of the embodiments discussed above can be located at a boundary or a corner of the ground plane. Further, all above-illustrated antennas can be either folded dipole antennas or loop antennas. Furthermore, the widths of the conductive antennas can be varied, or a part of the tracks can be modified to be zigzag formed or formed with turns, so as to adjust the antenna characteristics as desired.

In summary, the antenna of the present invention includes a plurality of conductive antenna tracks corresponding to a plurality of resonant frequencies, respectively. The resonant frequencies are independent from one another and do not affect one another. When it is desired to adjust a resonant frequency, only the resonant frequency desired to be adjusted and the conductive antenna track corresponding thereto are needed to be adjusted. As such, when the operation frequency bands of the antenna increases, the antenna can adaptively increase the conductive antenna track which corresponds to the increased operation frequency bands without varying the original conductive antenna track. In such a way, the antenna is simple and convenient to design. The present invention has the advantages of a simple structure, an easily controlled operation frequency, a small area, and a close feed point to the short circuit point. Further, the invention is different from most of the conventional antennas in which feed point and short circuit points must be positioned at the center of the ground planes from the mobile phone systems. The feed point and the short circuit point of the antenna according to the present invention can be distributed at a boundary or a corner of the ground plane of the system, thus achieving better flexibility in applications, especially for handheld device. Moreover, if a coupling phenomenon occurs between the increased conductive antenna track and the original conductive antenna track, the conductive element can be used for depressing the additional resonant frequency caused by the coupling phenomenon.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An antenna, applicable for handled device and operating at a plurality of operation frequencies, comprising:
a feed element;
a ground element; and
M conductive antenna tracks, located in a same plane, having an end coupled to the feed element and the other end coupled to the ground element respectively, wherein each of the conductive tracks forms an area for starting from a joint of the conductive antenna track and the feed element and extending along the conductive antenna track to a joint of the conductive antenna track and the ground element, wherein a k^{th} conductive antenna track defines a k^{th} area, and an i^{th} area is not overlapped with a j^{th} area, M is an integer greater than or equal to 2, i, j, and k are positive integers smaller than or equal to M, and i is not equal to j.

2. The antenna according to claim 1, wherein the conductive antenna tracks respectively correspond to a plurality of resonant frequencies, thus forming a plurality of frequency bands correspondingly covering the operation frequencies, respectively.

3. The antenna according to claim 2, wherein a length of each of the conductive antenna tracks is half of a wavelength corresponding to the resonant frequency of the conductive antenna track.

4. The antenna according to claim 2, wherein when the resonant frequency of each of the conductive antenna tracks operated at the antenna is double, current zeros configured on the conductive antenna tracks comprises a first current zero and a second current zero, the antenna further comprises a conductive element having a first end coupled to the first current zero and the other end coupled to the second current zero.

5. The antenna according to claim 1, wherein the antenna is a folded dipole antenna or a loop antenna.

6. The antenna according to claim 1, wherein said plane in which the conductive antenna tracks are located is parallel with a ground plane.

7. The antenna according to claim 1, wherein the conductive antenna tracks are located in a ground plane.

8. The antenna according to claim 1, wherein the feed element and the ground element are located at boundary or corner of a ground plane.

9. The antenna according to claim 1, wherein the ground element further comprises a plurality of ground sub-elements, for connecting the conductive antenna tracks.

10. The antenna according to claim 1, wherein a part of each of the conductive antenna tracks is zigzag formed or formed with many turns.

11. An antenna, applicable for handled device and operating at a plurality of operation frequencies, the antenna comprising:
a feed element;
a ground element; and
at least two conductive antenna tracks, located in different planes, and each of the conductive antenna tracks comprises an end coupled to the feed element and the other end coupled to the ground element, the conductive antenna tracks respectively corresponding to a plurality of resonant frequencies, thus forming a plurality of frequency bands correspondingly covering the operation frequencies, respectively.

12. The antenna according to claim 11, wherein a length of each of the conductive antenna track is half of a wavelength corresponding to the resonant frequency of the conductive antenna track.

13. The antenna according to claim 11, wherein when the resonant frequency of each of the conductive antenna tracks operated at the antenna is double, current zeros configured on the conductive antenna tracks comprises a first current zero and a second current zero, the antenna further comprises a conductive element having a first end coupled to the first current zero and the other end coupled to the second current zero.

14. The antenna according to claim 11, wherein the antenna is a folded dipole antenna or a loop antenna.

15. The antenna according to claim 11, wherein planes in which the conductive antenna tracks are located are parallel with a ground plane.

16. The antenna according to claim 11, wherein a part of each of the conductive antenna tracks is zigzag formed or formed with turns.

17. The antenna according to claim 11, wherein a part of the conductive antenna tracks is located in a plane in which a ground plane is located.

18. The antenna according to claim 11, wherein the feed element and the ground element are located at boundary or corner of a ground plane.

19. The antenna according to claim 11, wherein the ground element further comprises a plurality of ground sub-elements, for connecting the conductive antenna tracks.
